(19) United States
(12) Patent Application Publication
(10) Pub. No.: US 2013/0335520 A1
(43) Pub. Date: Dec. 19, 2013

(54) Robotic Camera System with Context Display

(71) Applicants: Patrick Campbell, Stevenson Ranch, CA (US); Vincent Pace, Shadow Hills, CA (US)

(72) Inventors: Patrick Campbell, Stevenson Ranch, CA (US); Vincent Pace, Shadow Hills, CA (US)

(21) Appl. No.: 13/527,211

(22) Filed: Jun. 19, 2012

(51) Int. Cl. H04N 5/232; H04N 7/00

(52) U.S. Cl. 348/36; 348/211.8; 348/E07.001; 348/E05.042

(57) ABSTRACT

Remotely operated camera systems and methods of operating a remote camera. A camera platform may include a primary scene camera having a first field of view, a context camera optically aligned with the primary scene camera and having a second field of view larger than the first field of view, and a pointing mechanism. A control station remote from the camera platform may include a display system to display images captured by the primary scene camera and the context camera, and an operator interface configured to accept operator inputs to control the primary scene camera, the context camera, and the pointing mechanism.

### BACKGROUND

1. Field

This disclosure relates to remotely controlled cameras for recording events in a stadium, arena, or theater environment.

2. Description of the Related Art

Sporting events and theatrical productions may be performed before live audiences in venues such as stadiums, arenas, and theaters. Such events may be recorded by one or more film or video cameras that are typically located outside of the seating regions of the venue. However, a camera located outside of the seating regions cannot reproduce the view of a fan or spectator within the venue. Thus, to provide a more realistic fan's perspective of an event, a camera may be placed within a seating region of the venue. To minimize the obstruction caused by a camera within a seating region, the camera may be remotely operated, which is to say the camera may be operated by a cameraman from a location other than the location of the camera.

Additionally, to capture a higher level of detail and excitement, remotely-operated cameras may be placed within or over the playing field, court, or stage where the event takes place. For example, remotely-operated cameras may be placed on the goal posts of a football field or the backboards on a basketball court, or may be caused to fly over the field on a SkyCam® or other camera platform.

When a camera is operated by a cameraman collocated with the camera, the cameraman may view the image captured by the camera through an optical viewfinder or on a viewfinder display. The cameraman may also simply look around the camera to view a much larger scene that is the context for the image captured by the camera. The cameraman may use the context to select the desired framing for the captured image. When filming live action, such as an athletic event, the cameraman may also use the context to anticipate the direction in which the action will move. The cameraman may also use the context to rapidly and smoothly point the camera to capture a different portion of the venue.

A cameraman operating a remote camera typically has a viewfinder display that shows the image captured by the camera, but does not have visibility of the context for that image. Thus the cameraman may have difficulty selecting the best image framing, difficulty tracking rapidly changing action, and difficulty aiming the camera to capture a different scene in a different portion of the venue.

### DESCRIPTION OF THE DRAWINGS

FIG. 1 is a schematic top view of several cameras in a venue.

FIG. 2 is a block diagram of a remotely operated camera.

FIG. 3A is a block diagram of a remotely operated camera.

FIG. 3B shows an exemplary display system.

FIG. 4A is a block diagram of another remotely operated camera.

FIG. 4B shows another exemplary display system.

FIG. 5A is a block diagram of another remotely operated camera.

FIG. 5B shows another exemplary display system.

FIG. 6A is a block diagram of another remotely operated camera.

FIG. 6B shows another exemplary display system.

FIG. 6C shows another exemplary display system.

FIG. 7A is a block diagram of another remotely operated camera.

FIG. 7B shows another exemplary display system.

FIG. 7C shows another exemplary display system.

Throughout this description, elements appearing in figures are assigned three-digit reference designators, where the most significant digit is the figure number where the element is introduced.

### DETAILED DESCRIPTION

Description of Apparatus

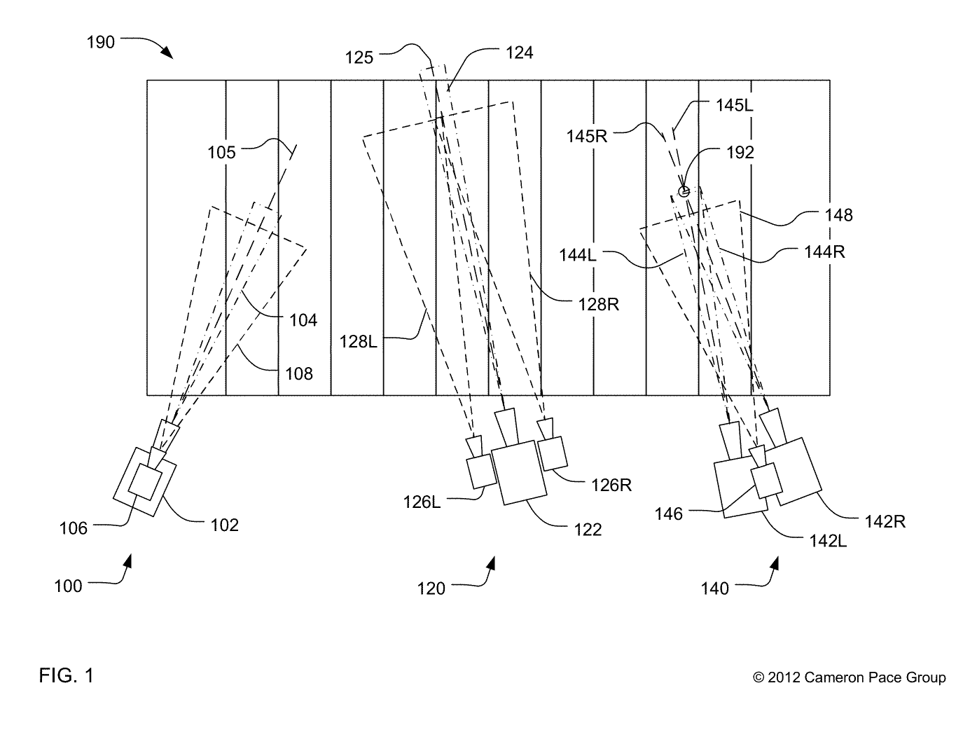

Referring now to FIG. 1, one or more remotely-operated camera systems may be used to capture an event occurring in a venue 190. In this example, the venue 190 is depicted as an American football field. The venue may be, for example, a soccer field, a basketball court, a hockey or figure skating rink, a ballroom, a stage, or any other venue where remotely-operated cameras may be used to capture some live action. In this context, “capture” means to convert a scene into an electronic format for recording and/or broadcast using one or more video cameras.

The example of FIG. 1 shows three different exemplary remotely-operated camera platforms 100, 120, 140, each of which includes a primary scene camera and a secondary or context camera. In this context, a “camera platform” is an apparatus including at least one camera where at least a portion of the controls for the camera are remotely located. Thus a “camera platform” is not a complete camera system. The primary scene camera may be configured and used for capturing a scene for recording and/or broadcast. In this context, the term “capturing” means converting an optical image of the scene into data or signals that can be recorded, broadcast, or otherwise utilized. The context camera may be configured and used for capturing a context image to provide context to a remote operator. The physical sizes of the cameras are substantially exaggerated with respect to the size of the venue.

The remotely-operated camera platform 100 includes a conventional (i.e. not 3D) primary scene camera 102 which captures an image over an angular field of view 104 centered on a line-of-sight 105. The field of view 104 may be fixed. The primary scene camera 102 may be equipped with a variable focal length or zoom lens (not identified), in which case the field of view 104 may be adjustable by setting the appropriate lens focal length.

The remotely-operated camera platform 100 includes a single context camera 106 which captures a context image over an angular field of view 108. The field of view 108 may be substantially larger than the field of view 104 of the primary scene camera 102. The context camera 106 may be optically aligned with the primary scene camera 102 such that the field of view 108 of the context camera 106 may encompass the field of view 104 of the primary scene camera 102. The context camera 106 may be optically aligned with the primary scene camera 102 such that the center of the field of view 108 may be nearly or exactly coincident with the line-of-sight 105 of the primary scene camera 102. The context camera 106 may be located, for example, on top of the primary scene camera 102 as shown.

The field of view 108 may be fixed, or may be adjustable if the context camera 106 is equipped with a zoom lens. When both the primary scene camera 102 and the context camera 106 are equipped with zoom lenses, the lenses may be coupled to synchronously change respective focal lengths such that the sizes of the fields of view 104 and 108 remain in constant or nearly constant proportion. As will be discussed subsequently, when the field of view 108 of the context camera 106 is fixed, digital zoom may be used to re-size the context image presented to the remote operator.

The remotely-operated camera platform 120 includes a conventional (i.e. not 3D) primary scene camera 122 which captures an image over an angular field of view 124 centered on a line-of-sight 125. The field of view 124 may be fixed or variable. The remotely-operated camera platform 120 includes a pair of context cameras 126L, 126R which, capture context images over respective angular fields of view 128L, 128R. The context cameras 126L, 126R may be optically aligned with the primary scene camera 122. The context cameras 126L, 126R may be located, for example, immediately to the left and right, respectively, of the primary scene camera 122 as shown.

Each of the fields of view 128L, 128R may be substantially larger than the field of view 124 of the primary scene camera 122. The fields of view 128L, 128R may overlap all or part of the field of view 124 of the primary scene camera 122, and may partially overlap each other. The fields of view 128L, 128R may be fixed or variable over a range from a widest field of view to a narrowest field of view. The context cameras 126L, 126R may be configured such that the narrowest fields of view overlap or are at least contiguous with the primary field of view 124. In this case, the widest fields of view may overlap.

The remotely-operated camera platform 140 includes a stereographic or 3D primary scene camera 142 comprising a left camera 142L and a right camera 142R which capture respective left and right images over respective angular fields of view 144L, 144R. The angular fields of view 144L, 144R may be centered on respective lines-of-sight 145L, 145R. The 3D primary scene camera 142 may be configured such that the lines-of-sight 145L, 145R converge or intersect at a scene object of interest 192 (such as a particular player). The fields of view 144L, 144R may be fixed. Each of the left camera 142L and the right cameras 142R may be equipped with a zoom lens (not identified), in which case the fields of view 144L, 144R may be adjustable by adjusting the focal length of the left and right lenses synchronously. One or both of the left camera 142L and the right camera 142R may be rotatable to cause the lines-of-sight 145L, 145R to intersect at any desired distance from the cameras.

The remotely-operated camera platform 140 includes a single context camera 146 which captures a context image over an angular field of view 148. The context camera 146 may be optically aligned with the 3D primary scene camera 142 such that the field of view 148 encompasses and is approximately centered on the fields of view 144L, 144R. The context camera 146 may be located, for example, on top of the 3D primary scene camera 142 as shown.

The field of view 148 may be substantially larger than the fields of view 144L, 144R of the primary scene camera 142. The field of view 148 may be fixed, or may be adjustable if the context camera 146 is equipped with a zoom lens. When both the 3D primary scene camera 142 and the context camera 146 are equipped with zoom lenses, the lenses may be coupled to synchronously change respective focal lengths such that the sizes of the fields of view 144L, 144R and 148 remain in proportion.

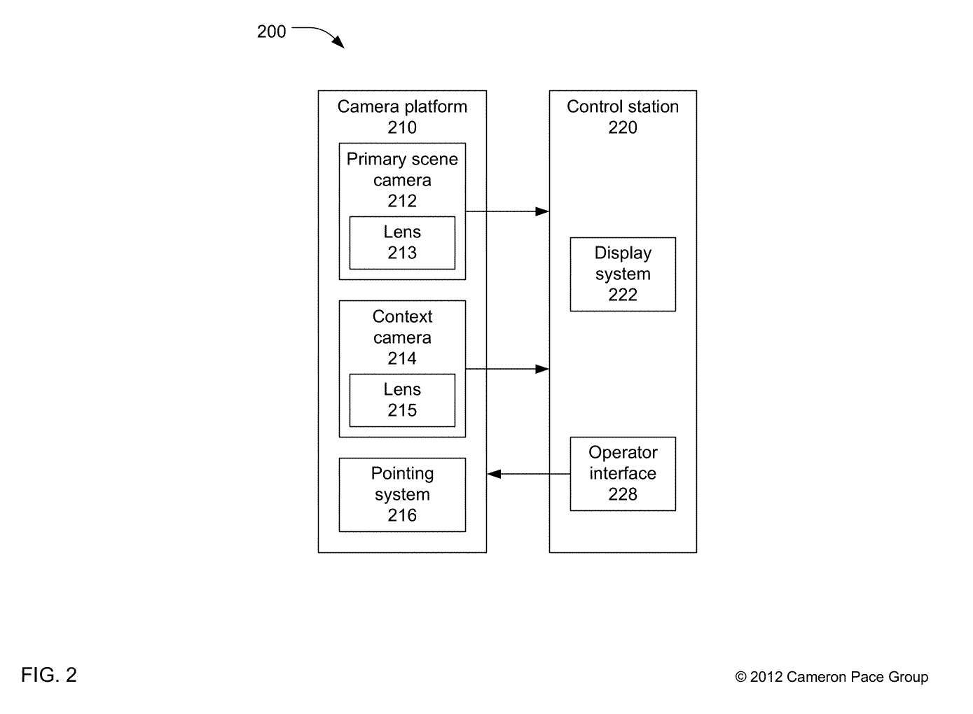

Referring now to FIG. 2, an exemplary remotely-operated camera system 200 may include a camera platform 210 and a separately located control station 220. The camera platform 210 and the control station 220 may be coupled by communications links to carry commands from the control station 220 to the camera platform 210 and to carry video data or signals from the camera platform 210 to the control station 220. These communications links may be wired, wireless, or optical.

The camera platform 210 may include a primary scene camera 212, which may be a conventional camera or a 3D camera, and one or more context camera 214. The camera platform may be the camera platform 100, 120, 140, or some other camera platform.

The camera platform 210 may include a pointing system 216 to change a line-of-sight of both the primary scene camera 212 and the context camera 214. The pointing system may include, for example a remotely-controlled pan and tilt mechanism to adjust a pan or azimuth angle and a tilt or elevation angle of the line-of-sight. The primary scene camera 212 and the context camera 214 may be physically attached and coupled to a single pan and tilt mechanism. The primary scene camera 212 and the context camera 214 may be in close proximity but physically separate. In this case, the cameras may be coupled to separate pan and tilt mechanisms that operate synchronously. In either case, the lines-of-sight of the primary scene camera 212 and the context camera 214 may be optically aligned such that the fields of view of the two cameras are centered on or near the same point in the scene.

The camera platform 210 may be supported by a structure, such as a tripod, stand, pedestal, or dolly, which is not shown in FIG. 2. Except for the adjustment of the pan and tilt angles, the camera platform 210 may be stationary during an event. Alternatively, the camera platform 210 may be mounted to a remotely-controlled motion mechanism that allows the location of the camera platform to move during an event or while recording a scene. For example, the camera platform 210 may be mounted to a vehicle, to a carriage that travels along preinstalled rails, or to a SkyCam® which uses a system of cables to “float” the camera platform in the air above a venue.

The primary scene camera 212 may be a conventional (2D) camera. A conventional primary scene camera 212 may include a lens 213 that may have fixed focal length or remotely-controlled variable focal length. A focus distance of the lens 213 may be remotely controlled, or may be automatically controlled by an autofocus system within the primary scene camera 212. In this patent, “automatically” means “without operator involvement”. An aperture setting of the lens 213 may be remotely controlled, or may be automatically controlled by an auto-exposure system within the primary scene camera 212.

The primary scene camera 212 may be a 3D camera. A 3D primary scene camera 212 may include left and right lenses (not shown). The focal length, focus distance, and aperture of the left and right lenses may be remotely controlled. The focus distance and aperture of the left and right lenses may be automatically controlled by an autofocus system and an auto-exposure system, respectively. The focal length, focus distance, and aperture of the left and right lenses may be controlled synchronously, which is to say the focal length, focus distance, and aperture of the left and right lenses may be closely matched at any setting.

The resolution and format of the primary scene camera 212 may be determined by the intended use of the video images captured by the camera. For example, for live broadcasting, the primary scene camera may be a 525i conventional television camera or a 720p, 1080i, or 1080p HDTV camera. For cinematic recording, the primary scene camera may have substantially higher resolution.

The camera platform 210 may include one, two, or more context cameras 214. Each context camera 214 may be a conventional (2D) camera. Each context camera 214 may include a lens 215 that has a fixed focal length or a variable focal length. When the focal length of lens 215 is variable, the focal length may be remotely controlled or set based on the focal length of the primary scene camera lens or lenses. For example, the focal length of the lens 215 may be set such that a field of view of the context camera 214 and a field of view of the primary scene camera 212 remain in constant, or nearly constant, proportion for any setting of the primary scene camera focal length.

The resolution and format of the one or more context cameras 214 may be the same or different from the primary scene camera 212. For example, each of the one or more context cameras may be conventional 525i television cameras and the primary scene camera 212 may be an HDTV camera.

A focus distance of the lens 215 of the context camera 214 may be remotely controlled, may be automatically controlled by an autofocus system within the context camera 214, or may be set equal to the focus distance of the lens or lenses in the primary scene camera 212. An aperture setting of the lens 215 may be remotely controlled, may be automatically controlled by an auto-exposure system within the context camera 214, or may be controlled based on an aperture set for the lens or lenses of the primary scene camera 212.

The control station 220 may include a display system 222 to present images from the primary scene camera 212 and the context camera 214 to an operator. The display system 222 may be configured to display the image from the primary scene camera with sufficient resolution and quality for the operator to verify that the focus distance and aperture of the primary scene camera are appropriately adjusted. The display system 222 may be configured to display the image from the context camera with sufficient resolution and quality for the operator to anticipate the action occurring in the venue and to efficiently move the line-of-sight of the primary scene camera to different scenes within the venue. Several embodiments of the display system 222 will be discussed subsequently.

The control station 220 may include an operator interface 228 to receive operator commands for controlling the pointing system 216 and the primary scene camera 212. Operator commands may be received for independently controlling the pan and tilt mechanism within the pointing system 216 and, where available, for controlling the location of the camera platform within the venue. Operator commands may be received for setting a focal length of the primary scene camera and for setting a focus distance and/or aperture of the primary scene camera when those parameters are not automatically controlled. Operator commands may directly control the focal length and aperture settings of the context camera 214, or may indirectly control the focal length and aperture settings of the context camera 214 when those parameters are set based on the parameters of the primary scene camera 212.

A nearly unlimited number of configurations are possible for the operator interface 228. For example, an operator interface for remotely controlled cameras may mimic the physical layout of an actual camera, with camera controls located on movable arms coupled to a pan and tilt mechanism. With this operator interface, the remote operator uses essentially the same body motions and control actions as when controlling an actual camera. An operator interface may include other types of controls, such as a joystick, trackball, or other pointing device to enter commands for the pan and tilt mechanism and rotary or linear slide controls for entering commands for camera functions.

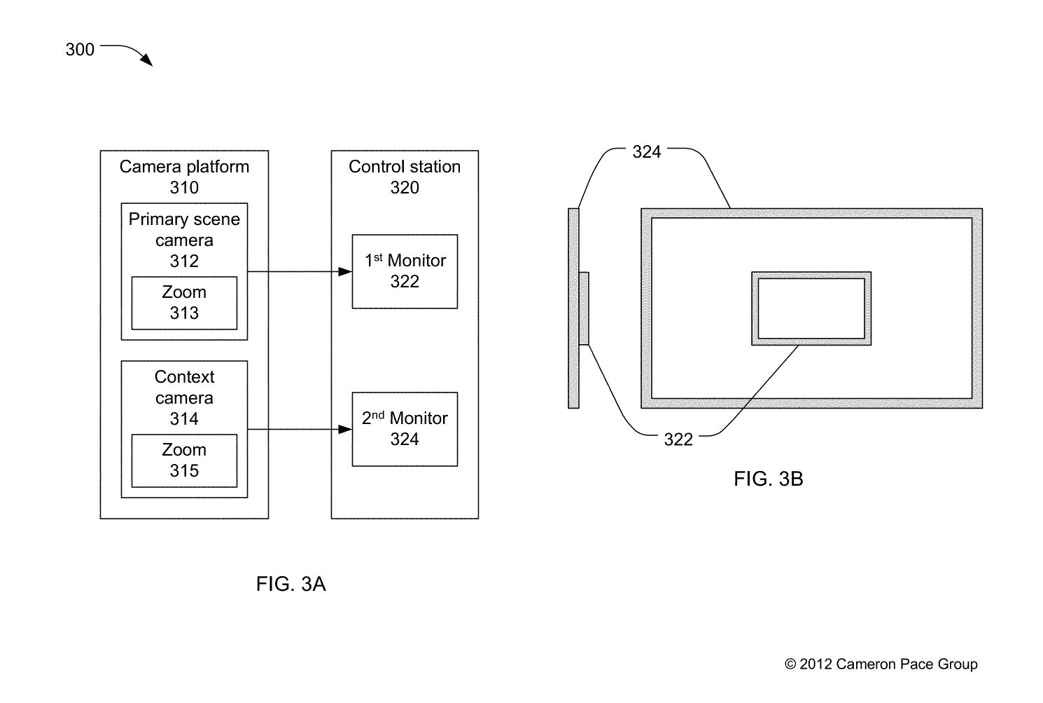

FIGS. 3A, 4A, 5A, 6A, and 7A are block diagrams of exemplary camera and display system combinations for remotely-controlled camera systems. Although not shown in these figures, the camera platform of each remotely-controlled camera system may include a pointing system, such as the pointing system 216. Additionally, the control station of each remotely-controlled camera may include an operator interface, such as the operator interface 228.

Referring now to FIG. 3A, a remotely-controlled camera system 300 may include a camera platform 310 and a separately-located control station 320. The camera platform 310 may include a 2D or 3D primary scene camera 312 and a single context camera 314. The control station 320 may include a first monitor 322 to display the image captured by the primary scene camera 312 and a second monitor 324 to display the image captured by the context camera 314. In this patent, the term “monitor” has the industry standard meaning of “a display used to check the quality or content of a visual image”.

The first monitor 322 may have sufficient resolution and image quality to allow an operator to confirm that the primary scene camera is properly focused on the scene being captured. For example, when the primary scene camera 312 is a 720p, 1080i, or 1080p HDTV camera, the first monitor 322 may be a compatible HDTV display. When the primary scene camera 312 is a 3D camera, the first monitor 322 may be a 3D display or a 2D display showing either of the left or right images from the primary scene camera. The resolution of the second monitor 324 may be matched to the resolution of the context camera 314 and may be the same or lower than the resolution of the first monitor 322.

The second monitor 324 may have a substantially larger viewing area than the first monitor 322. As shown in FIG. 3B, the first monitor 322 may be a liquid crystal or other flat panel display positioned in front of the second monitor 324 to provide a high resolution “window” in the scene captured by the context camera 314.

When the first monitor is positioned in front of the second monitor as shown in FIG. 3B, the images presented on the first and second monitors 322, 324 may have approximately the same magnification, such that scene objects do not abruptly change size when moving from one monitor to the other. To provide the same magnification, the field of view of the context camera 314 and the field of view of the primary scene camera 312 may be approximately proportional to the size of the second monitor 324 and the size of the first monitor 322 respectively. In this context, “approximately proportional” means proportional to a sufficient degree that a change in size of image objects moving between the first monitor and the second monitor is not objectionable or distracting to the camera operator.

The primary scene camera 312 may include a zoom mechanism 313. Typically, the zoom mechanism 313 is implemented optically (i.e. by a variable focal length lens) and controlled by the operator from the control station. In order to maintain a constant ratio of the field of view of the context camera to the field of view of the primary scene camera, the context camera 314 may also have a zoom function 315. The zoom function 315 of the context camera 314 may be implemented optically. The zoom function 315 of the context camera 314 may be implemented by a digital zoom (i.e. using digital signal processing to crop the image captured by the context camera and then expand the cropped image to fill the area of the second monitor 324). The digital zoom processing may be implemented within the context camera 314 or the control station 320. Digital zoom processing may reduce the resolution of the image presented on the second display (since less than all of the resolution of the context camera is actually displayed). The resolution of the digitally-zoomed image may be sufficient to inform the operator of the context of the image captured by the primary scene camera 312. The zoom function 315 of the context camera 314 may be implemented by a combination of a variable focal length lens and digital processing. In any event, the zoom mechanism 313 of the primary scene camera 312 and the zoom function 315 of the context camera 314 may be synchronized such that the images presented on the first monitor 322 and the second monitor 324 remain in proportion.

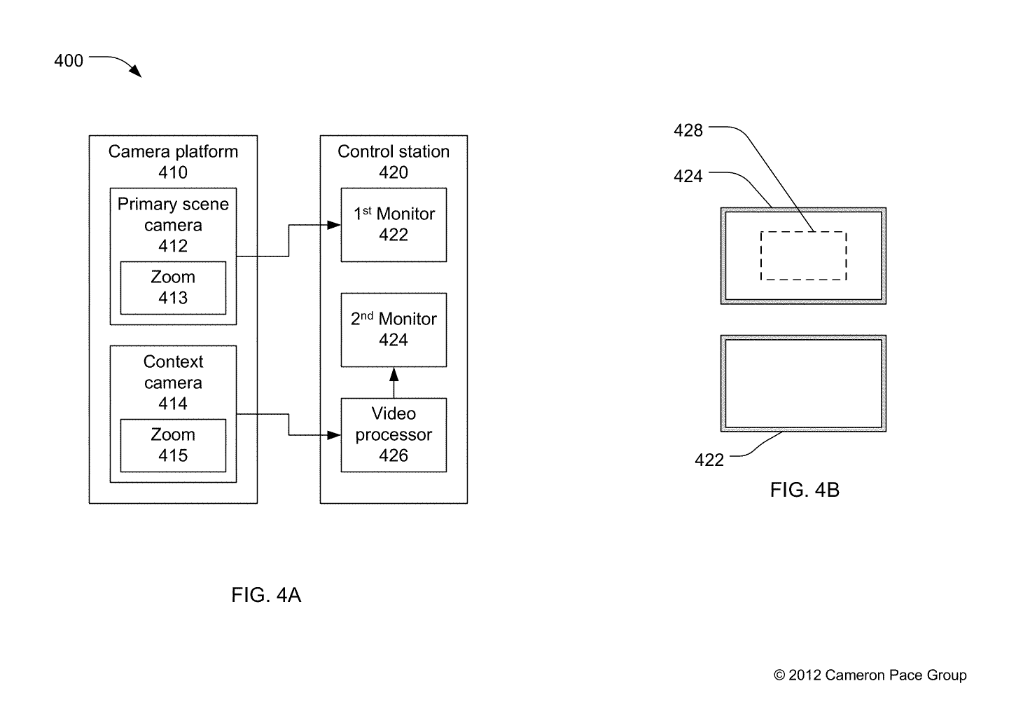

Referring now to FIG. 4A, a remotely-controlled camera system 400 may include a camera platform 410 and a separately-located control station 420. The camera platform 410 may include a 2D or 3D primary scene camera 412 and a single context camera 414. The primary scene camera 412 and the context camera 414 may be optically aligned such that the fields of view of the primary and context cameras overlap. The primary scene camera 412 and the context camera 414 may be optically aligned such that the fields of view of the primary and context cameras are centered on the same scene object.

The control station 420 may include a first monitor 422 to display the image captured by the primary scene camera 412 and a second monitor 424 to display the image captured by the context camera 414. As shown in FIG. 4B, the first monitor 422 and the second monitor 424 are adjacent, which is to say the first monitor and the second monitor are separate non-overlapping display devices disposed in proximity to each other. The first monitor 422 may have sufficient resolution and image quality to allow an operator to confirm that the primary scene camera 412 is properly focused on the scene being captured. The resolution of the second monitor 424 may be matched to or higher than the resolution of the context camera 414 and may be the same or lower than the resolution of the first monitor 422. For convenience, the first monitor and the second monitor may be identical display devices.

The primary scene camera 412 may have a zoom function which may typically be an optical zoom. The context camera 414 may have a fixed field of view. The context camera 414 may have a zoom function 415 implemented optically, digitally, or optically and digitally in combination. The zoom function 415 may be synchronized with the zoom 413 of the primary scene camera 412 or may be independently controlled.

The images presented on the first and second monitors 422, 424 may have different magnification, such that a scene object shown on both monitors will appear substantially larger on the first monitor 422 than on the second monitor 424. To assist the operator in understanding the context shown on the second monitor 424, a video processor 426 may add a rectangular graphic 428 to the image captured by the context camera 414. The extent of the rectangular graphic 428 may define an extent of the image displayed on the first monitor 422. The rectangular graphic 428 may be a dashed line, as shown, or a solid line and may be distinguished from the image captured by the context by brightness, color, or some other technique. The size of the rectangular graphic may vary with the zoom function 413 of the primary scene camera 412. In lieu of or in addition to the rectangular graphic 428, the video processor 426 may alter the brightness or some other image feature to distinguish the extent of the image captured by the primary scene camera.

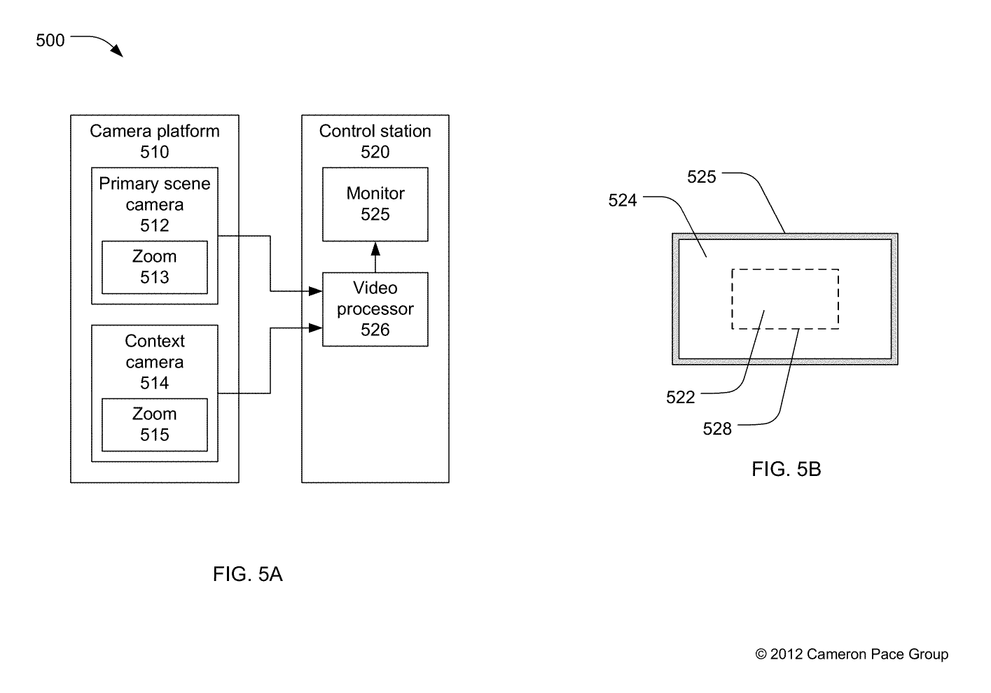

Referring now to FIG. 5A, a remotely-controlled camera system 500 may include a camera platform 510 and a separately-located control station 520. The camera platform 510 may include a 2D or 3D primary scene camera 512 and a single context camera 514. The primary scene camera 512 and the context camera 514 may be optically aligned such that the fields of view of the primary and context cameras overlap. The primary scene camera 512 and the context camera 514 may be optically aligned such that the fields of view of the primary and context cameras are centered on the same scene object.

The control station 520 may include a single monitor 525. The image captured by the primary scene camera 512 and the image captured by the context camera 514 may be combined by a video processor 526 for display on the monitor 525. As shown in FIG. 5B, a central portion 522 of the monitor 525 may display the image from the primary scene camera 512, and a peripheral portion of the monitor 525 may display the image captured by the context camera 514. The central portion 522 of the monitor 525 may have sufficient resolution and image quality to allow an operator to confirm that the primary scene camera 512 is properly focused on the scene being captured. The overall resolution of the monitor 525 may be substantially higher that the resolution of the primary scene camera 512. For example, when the primary scene camera 512 is a 1080i or 1080p HDTV camera, the monitor 525 may have a resolution of 1600×2560 picture elements or 2160×3840 picture elements, or some other resolution.

The images captured by the primary scene camera 512 and the context camera 514 may be presented on the monitor 525 with same magnification, such that scene objects do not abruptly change size when moving the peripheral portion 524 and the central portion 522. To provide the same magnification, a ratio of the field of view of the context camera 514 to the field of view of the primary scene camera 512 may be approximately the same as a ratio of the size of the monitor 525 to the size of the central portion 522.

The primary scene camera 512 may include an optical image zoom mechanism 513 controlled by the operator from the control station. In order to maintain a constant ratio of the field of view of the context camera to the field of view of the primary scene camera, the context camera 514 may also have a zoom function 515 which may be implemented optically, digitally, or by a combination of optical and digital techniques. The zoom mechanism 513 of the primary scene camera 512 and the zoom function 515 of the context camera 514 may be synchronized such that the images presented on the central portion 522 and the peripheral portion 524 of the monitor 525 remain in proportion.

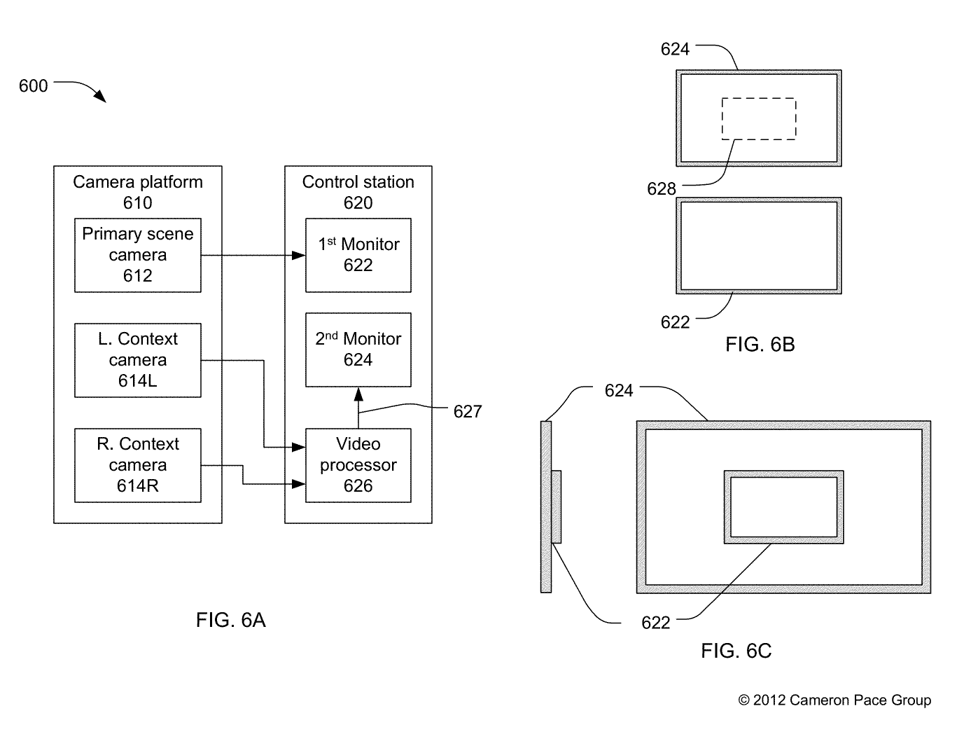

Referring now to FIG. 6A, a remotely-controlled camera system 600 may include a camera platform 610 and a separately-located control station 620. The camera platform 610 may include a 2D or 3D primary scene camera 612 and left and right context cameras 614L, 614R. The primary scene camera 612 and the context cameras 614L, 614R may be optically aligned such that the fields of view of the primary and context cameras overlap.

The control station 620 may include a first monitor 622 to display the image captured by the primary scene camera 612. A video processor 626 may combine the images captured by the left and right context cameras 614L, 614R into a single “panoramic” context image 627 for display on a second monitor 624. Techniques for combining overlapping images into a single panoramic image are well known for still images and readily adaptable for video images.

As shown in FIG. 6B, the first monitor 622 and the second monitor 624 may be separate display device disposed in proximity. The first monitor 622 may have sufficient resolution and image quality to allow an operator to confirm that the primary scene camera 612 is properly focused on the scene being captured. The resolution of the second monitor 624 may be suitable for presenting the panoramic context image 627, and may be the same or lower than the resolution of the first monitor 622. For convenience, the first monitor 622 and the second monitor 624 may be identical display devices.

The primary scene camera 612 may have a zoom function (not shown) which may typically be an optical zoom. The context cameras 614L, 614R may have fixed fields of view. The context cameras 614L, 614R may have a zoom function implemented optically, digitally, or optically and digitally in combination. The zoom function of the context cameras 614L, 614R may be synchronized with the zoom of the primary scene camera 612 or may be independently controlled.

When the first and second monitors 622, 624 are disposed as shown in FIG. 6B, the images presented on the first and second monitors 622, 624 may have different magnification. In this case, a scene object shown on both monitors will appear substantially larger on the first monitor 622 than on the second monitor 624. To assist the operator in understanding the context shown on the second monitor 624, the video processor 626 may add a rectangular graphic 628 to the panoramic context image 627 or use some other technique to distinguish the extent of the image captured by the primary scene camera 612.

As shown in FIG. 6C, the first monitor 622 may be a liquid crystal or other flat panel display positioned in front of a substantially larger second monitor 624 to provide a high resolution “window” in the scene captured by the context cameras 614L, 614R.

When the first monitor is positioned in front of the second monitor as shown in FIG. 6C, the images presented on the first and second monitors 622, 624 may have approximately the same magnification, such that scene objects do not abruptly change size when moving from one monitor to the other. To provide the same magnification, a ratio of the field of view of the context cameras 614L, 614R to the field of view of the primary scene camera 612 may be approximately the same as a ratio of the size of the second monitor 624 to the size of the first monitor 622. A zoom mechanism (not shown) of the primary scene camera 612 and a zoom function (not shown) of the context cameras 614L, 614R may be synchronized such that the respective fields of view remain in proportion.

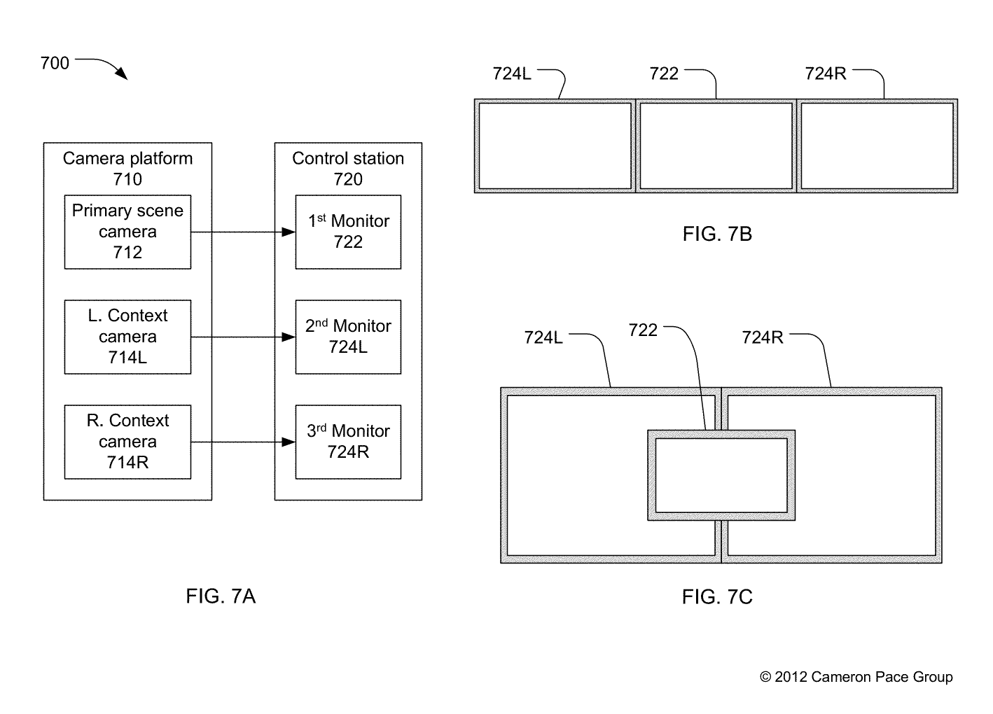

Referring now to FIG. 7A, a remotely-controlled camera system 700 may include a camera platform 710 and a separately-located control station 720. The camera platform 710 may include a 2D or 3D primary scene camera 712 and left and right context cameras 714L, 714R. The primary scene camera 712 and the context cameras 714L, 714R may be optically aligned such that the fields of view of the primary and context cameras overlap.

The control station 720 may include a first monitor 722 to display the image captured by the primary scene camera 712. The control station 720 may include a second monitor 724L and a third monitor 724R to display images captured by the left and right context cameras 714L, 714R respectively.

As shown in FIG. 7B, the first monitor 722, the second monitor 724L and the third monitor 724R may be separate display devices disposed in proximity. The first monitor 722 may have sufficient resolution and image quality to allow an operator to confirm that the primary scene camera 712 is properly focused on the scene being captured. The resolution of the second and third monitors 724L, 724R may be suitable for presenting the images captured by the context cameras 714L, 714R, and may be the same or lower than the resolution of the first monitor 722.

As shown in FIG. 7C, the first monitor 722 may be a liquid crystal or other flat panel display positioned in front of a pair of substantially larger second monitors 724L, 724R, to provide a high resolution “window” in the scene captured by the context cameras 714L, 714R.

The primary scene camera 712 may have a zoom function (not shown) which may typically be an optical zoom. The context cameras 714L, 714R may have fixed fields of view. The context cameras 714L, 714R may have a zoom function implemented optically, digitally, or optically and digitally in combination.

When the first monitor 722 is positioned adjacent to or in front of the second and third monitors 724L, 724R as shown in FIG. 7B or FIG. 7C, the images presented on the first, second, and third monitors 722, 724L, 724R may have approximately the same magnification, such that scene objects do not abruptly change size when moving from one monitor to the other. To provide the same magnification, a ratio of the field of view of the context cameras 714L, 714R to the field of view of the primary scene camera 712 may be approximately the same as a ratio of the size of the second monitor 724 to the size of the first monitor 722. A zoom mechanism (not shown) of the primary scene camera 712 and a zoom function (not shown) of the context cameras 714L, 714R may be synchronized such that the respective fields of view remain in proportion.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A remotely operated camera system, comprising:
a camera platform including:
a primary scene camera having a first field of view,
a context camera optically aligned with the primary scene camera, the context camera having a second field of view larger than the first field of view, and
a pointing mechanism; and
a control station remote from the camera platform including:
a display system to display images captured by the primary scene camera and the context camera; and
an operator interface configured to accept operator inputs to control the primary scene camera, the context camera, and the pointing mechanism.

2. The remotely operated camera system of claim 1, wherein
the display system comprises a first monitor to display the image from the primary scene camera and a second monitor to display the image from the context camera.

3. The remotely operated camera system of claim 2, wherein
relative sizes of the first monitor and the second monitor are approximately proportional to the first field of view and the second field of view, respectively, and
the first monitor is positioned in front of the second monitor for viewing.

4. The remotely operated camera system of claim 2, wherein
the first monitor and the second monitor are adjacent, and
the system further comprises a video processor to add a rectangular graphic to the image displayed on the second monitor, the graphic indicating an extent of the image displayed on the first monitor.

5. The remotely operated camera system of claim 1, wherein
the display system comprises a single display screen to display images captured by both the primary scene camera and the context camera, and
the camera system further comprises a video processor to combine the image captured by the primary scene camera and the image captured by the context camera for display on the display screen.

6. The remotely operated camera system of claim 5, wherein
the video processor is configured to add a rectangular graphic to the image displayed on the display screen, the graphic indicating an extent of the first field of view.

7. The remotely operated camera system of claim 1, wherein
the primary scene camera includes an operator-controlled zoom mechanism to change the first field of view, and
the context camera includes a zoom function to automatically change the second field of view to maintain approximately constant proportion between the first field of view and the second field of view.

8. The remotely operated camera system of claim 7, wherein the zoom function of the context camera is implemented, at least in part, digitally.

9. The remotely operated camera system of claim 1, wherein the context camera comprises a left context camera and a right context camera with substantially non-overlapping fields of view.

10. The remotely operated camera system of claim 9, further comprising:
a video processor to form a panoramic context image from the images captured by the left context camera and the right context camera,
wherein the display system comprises a first monitor to display the image from the primary scene camera and a second monitor to display the panoramic context image.

11. The remotely operated camera system of claim 10, wherein the first monitor is positioned in front of the second monitor for viewing.

12. The remotely operated camera system of claim 10, wherein
the first monitor and the second monitor are adjacent, and
the video processor to adds a rectangular graphic to the panoramic context image, the graphic indicating an extent of the image displayed on the first monitor.

13. The remotely operated camera system of claim 9, wherein
the display system comprises a first monitor to display the image from the primary scene camera, a second monitor to display the image from the left context camera, and a third monitor to display the image from the right context camera.

14. A method of operating a remote camera system, comprising:
capturing a primary scene image with a primary scene camera having a first field of view;
capturing a context image with a context camera optically aligned with the primary scene camera, the context camera having a second field of view larger than the first field of view; and
displaying both the primary scene image and the context image to an operator remotely located from the primary scene camera and the context camera.

15. The method of operating a remote camera system of claim 14, wherein displaying both the primary scene image and the context image comprises displaying the primary scene image on a first monitor and displaying the context image on a second monitor.

16. The method of operating a remote camera system of claim 15, wherein
relative sizes of the first monitor and the second monitor are approximately proportional to the first field of view and the second field of view, respectively, and
the first monitor is positioned in front of the second monitor for viewing.

17. The method of operating a remote camera system of claim 15, wherein
the first monitor and the second monitor are physically separate, and
the method further comprises processing the context image to add a rectangular graphic indicating an extent of the image displayed on the first monitor.

18. The method of operating a remote camera system of claim 14, wherein
displaying both the primary scene image and the context image comprises displaying the primary scene image and the context image on a single display screen, and
the method further comprises combining the image captured by the primary scene camera and the image captured by the context camera to provide a combined image for display on the display screen.

19. The method of operating a remote camera system of claim 18, wherein the method further comprises processing the combined image to add a rectangular graphic indicating an extent of the first field of view.

20. The method of operating a remote camera system of claim 14, further comprising:
an operator controlling a zoom mechanism of the primary scene camera to change the first field of view, and
automatically changing the second field of view to maintain approximately constant proportion between the first field of view and the second field of view.

21. The method of operating a remote camera system of claim 14, wherein capturing a context image with a context camera further comprises capturing a left context image with a left context camera and capturing a right context image with a right context camera.

22. The method of operating a remote camera system of claim 21, further comprising:
processing the left context image and the right context image to form a panoramic context image,
wherein displaying both the primary scene image and the context image comprises displaying the primary scene image on a first monitor and the panoramic context image on a second monitor.

23. The method of operating a remote camera system of claim 22, wherein the first monitor is positioned in front of the second monitor for viewing.

24. The method of operating a remote camera system of claim 22, wherein
the first monitor and the second monitor are adjacent, and
the method further comprises adding a rectangular graphic to the panoramic context image, the graphic indicating an extent of the image displayed on the first monitor.

25. The method of operating a remote camera system of claim 21, wherein
displaying both the primary scene image and the context image comprises displaying the primary scene image on a first monitor, displaying the left context image on a second monitor, and displaying the right context image on a third monitor.
